(19) United States
(12) Patent Application Publication
(10) Pub. No.: US 2009/0164433 A1
(43) Pub. Date: Jun. 25, 2009

(54) Method and System for Managing Search Results in a Communication Network

(75) Inventors: Seshadri R., Bangalore (IN); Suresh Kumar Chintada, Bangalore (IN)

Correspondence Address: MOTOROLA INC, 600 NORTH US HIGHWAY 45, W4 - 39Q, LIBERTYVILLE, IL, 60048-5343, US

(73) Assignee: MOTOROLA, INC., Schaumburg, IL (US)

(21) Appl. No.: 12/334,757

(22) Filed: Dec. 15, 2008

(30) Foreign Application Priority Data
Dec. 20, 2007 (IN) 2680/DEL/2007

(51) Int. Cl. G06F 17/30

(52) U.S. Cl. 707/3; 707/E17.014

(57) ABSTRACT

The present invention provides a method for managing persistent search query in a communication network (100). The method includes sending (304) a persistent search query from a communication device (102) to a network device (104). The persistent search query includes a search criteria, a set of result delivery parameters, and initial context information. Further, the method includes sending (306) a context information update to the network device. The context information update indicating a current context of the communication device relevant to the persistent search query. Furthermore, the method includes receiving (308) a set of persistent search query results at the communication device the first node to a third transmit power level.

### FIELD OF INVENTION

The present invention generally relates to communication networks, and more particularly, to a method and system for managing search results in a communication network.

### BACKGROUND OF THE INVENTION

Now days, obtaining information on any topic simply requires searching a database for the desired information. Usually, these databases are available online on the Internet. As a result, online searching is widely used to obtain any content available on a communication network, such as the Internet and mobile Internet. Further, many communication devices support applications which help users to conduct online searches. For example, a user can search for a desired content available on the Internet by using a mobile phone. The content can be songs, images, movies, wallpapers, ringtones, web sites, information on any topic etc. Examples of the communication device can include, but are not limited to, a mobile phone, a smart phone, a laptop, a computer, a pager, a Personal Digital Assistant (PDA), and a Voice over Internet Protocol (VoIP) phone.

One of the known methods allows a user to receive search results, based on search conducted at various online search engines. The user can periodically receive relevant results at the communication device based on matching of the search criteria. In accordance with one method, a user can search a database by using persistent search queries. Persistent search queries allow users to enter a search query just once and then receive constant, near real-time, or periodic automatic updates if any new content matching their search criteria is available on a database. However, these methods may not account for changing context of the user and communication device while delivering persistent search query results. The context can be, for example, if the user is at a particular location, what applications are running on the communication device, what is the traffic congestion in the network, and the like. Delivering results by taking changing context into account may be required to provide results that are more relevant and useful to current context of the users.

There are several methods that account for changing context of the communication device while delivering search results. One of these methods allows users to receive news alerts results based on the location of their communication device. However, this method accounts only for the location of a communication device and not other contexts, like network congestion and applications active on the communication device. Hence, only canned new alert functionality is available but persistent search queries based on specific parameters are not available today. Another method supports periodic delivery of alerts such as canned news alerts based on the location of the communication device or whenever the searched data is available on a database, i.e. whenever the searched content changes in the server or network and not based on client's context. However, this method is method periodically sends messages to the communication device and does not take into account other contexts of the communication device.

The above mentioned methods allow users to receive results based on only the search query and limited context of the communication device, like location. These methods do not provide persistent search query results based on an exhaustive list of relevant context of the communication device, user or the communication network. Also, existing methods do not deliver search results based on changing context of the user, communication network, and/or communication device.

### BRIEF DESCRIPTION OF THE FIGURES

The accompanying figures, where like reference numerals refer to identical or functionally similar elements throughout the separate views, and which, together with the detailed description below, are incorporated in and form part of the specification, serve to further illustrate various embodiments and explain various principles and advantages, all in accordance with the present invention.

FIG. 1 illustrates a communication network, where various embodiments of the present invention can be practiced;

FIG. 2 illustrates a block diagram of an exemplary communication device, in accordance with some embodiments of the present invention;

FIG. 3 is a flow diagram illustrating a method for managing persistent search query in a communication network, in accordance with an embodiment of the present invention; and

FIGS. 4 and 5 illustrate a flow diagram of a method for managing persistent search query in a communication network, in accordance with another embodiment of the present invention.

Skilled artisans will appreciate that elements in the figures are illustrated for simplicity and clarity and have not necessarily been drawn to scale. For example, the dimensions of some of the elements in the figures may be exaggerated, relative to other elements, to help in improving an understanding of the embodiments of the present invention.

### DETAILED DESCRIPTION

Before describing in detail the particular method and system for managing search results in a communication network, in accordance with various embodiments of the present invention, it should be observed that the present invention resides primarily in combinations of method steps related to the method and system for managing search results in a communication network. Accordingly, the apparatus components and method steps have been represented, where appropriate, by conventional symbols in the drawings, showing only those specific details that are pertinent for an understanding of the present invention, so as not to obscure the disclosure with details that will be readily apparent to those with ordinary skills in the art, having the benefit of the description herein.

In this document, the terms “comprises,” “comprising”, or any other variation thereof, are intended to cover a non-exclusive inclusion, such that a process, method, article or apparatus that comprises a list of elements does not include only those elements but may include other elements that are not expressly listed or inherent in such a process, method, article or apparatus. An element proceeded by “comprises . . . a” does not, without more constraints, preclude the existence of additional identical elements in the process, method, article or apparatus that comprises the element. The term “another,” as used in this document, is defined as at least a second or more. The terms “includes” and/or “having,” as used herein, are defined as comprising.

In the description herein, numerous specific examples are given to provide a thorough understanding of various embodiments of the invention. The examples are included for illustrative purpose only and are not intended to be exhaustive or to limit the invention in any way. It should be noted that various equivalent modifications are possible within the spirit and scope of the present invention. One skilled in the relevant art will recognize, however, that an embodiment of the invention can be practiced with or without the apparatuses, systems, assemblies, methods, components mentioned in the description.

For one embodiment, a method for managing persistent search query in a communication network is provided. The communication network includes a communication device and a network device. The method includes sending a persistent search query from the communication device to the network device. The persistent search query includes a search criteria, a set of result delivery parameters, and initial context information. Further, the method also includes sending a context information update from the communication device to the network device. The context information update indicates a current context of the communication device relevant to the persistent search query. Furthermore, the method includes receiving a set of persistent search query results at the communication device from the network device based on the search criteria and a comparison of the context information update with the set of result delivery parameters.

For another embodiment, a communication device for managing persistent search query in a communication network is provided. The communication device includes a persistent search query generator, a transmitter, and a receiver. The persistent search query generator is configured to generate a persistent search query. The persistent search query includes a search criteria, a set of result delivery parameters, and initial context information. Further, the transmitter is adapted to send a persistent search query to a network device in the communication network. The transmitter is also adapted to send context information update to the network device. The context information update indicates a current context of the communication device relevant to the persistent search query. Furthermore, the receiver is adapted to receive a set of persistent search query results at the communication device from the network device based on the search criteria and a comparison of the context information update with the set of result delivery parameters.

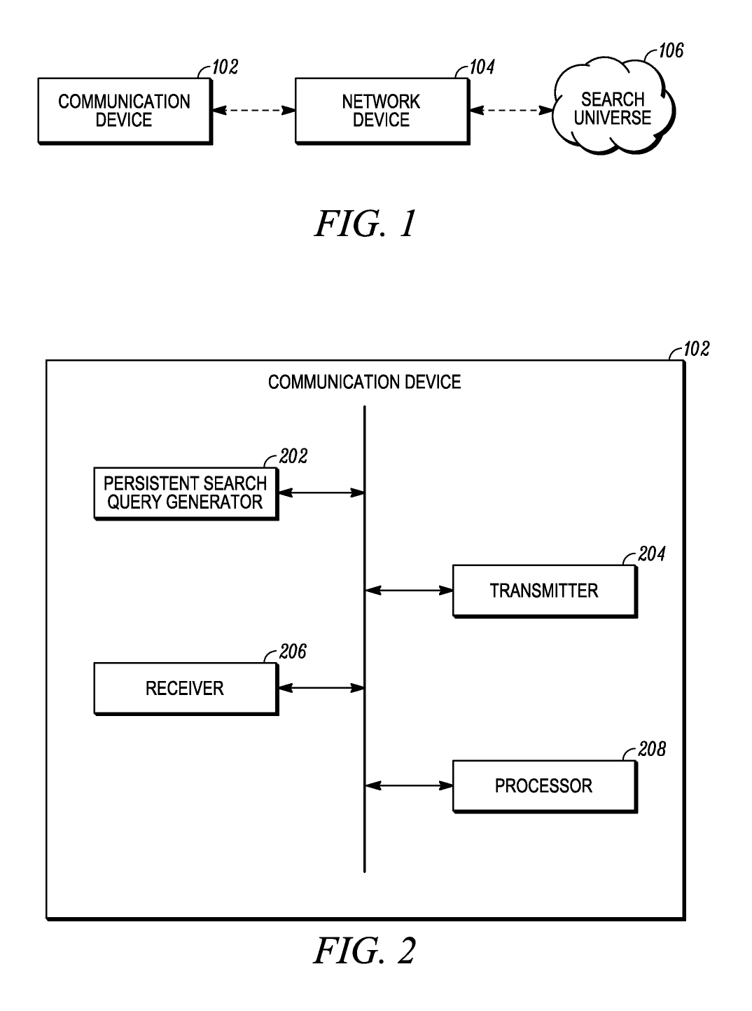

FIG. 1 illustrates a communication network 100, where various embodiments of the present invention can be practiced. The communication network 100 can include one or more communication devices and one or more network devices. Examples of the communication network 100 include, but are not limited to, a Wireless Local Area Network (WLAN), a Wireless Wide Area Network (WWAN), a Wireless Fidelity Network (Wi-Fi), a Wireless Interoperability for Microwave Access (WIMAX), a LAN, a WAN, a High Performance Radio Local Area Network (HIPERLAN), mobile communication network, etc.

The communication network 100 includes a communication device 102, a network device 104, and a search universe 106. Although FIG. 1 depicts the communication device 102 and network device 104, it will be apparent to a person ordinarily skilled in the art that the communication network 100 can include more than one communication and network devices. Examples of the communication device 102 include, but are not limited to, a mobile phone, a smart phone, a laptop, a computer, a pager, a Personal Digital Assistant (PDA), a Voice over Internet Protocol (VoIP) phone. The communication device 102 can search for any desired content in the search universe 106 by sending a persistent search query to the network device 104. A persistent search query allows users to enter a search query just once and then receive constant, near real-time, automatic search results whenever new content that meets their search criteria is available on the search universe 106. When a user of the communication device 102 does not want to receive search results of the persistent search query in future, the user can revoke the persistent search query. Examples of the content include, but are not limited to, songs, wallpapers, ringtones, images, software application, and information on any topic. Also, the communication devices in the network 100 can interact with the network device 104 by using a wireless communication link or a wireless transmission channel. Examples of the wireless transmission channel include, but are not limited to, a Local Multipoint Distribution Service (LMDS), a Cellular Digital Packet Data (CDPD), a Mobitex, a High Speed Downlink Packet Access (HSDPA), a Code Division Multiple Access (CDMA), a Global System for Mobile communications (GSM), a Universal Mobile telecommunications Service (UMTS), a General Packet Radio Service (GPRS), a radio wave link, an electromagnetic wave link, a microwave link, a Bluetooth® link, and an Infrared Data Association (IrDA) link.

The network device 104 enables the communication device 102 to access the search universe 106 and hence acts as an intermediate device. Examples of the network device 104 include, but are not limited to, a search engine, a Base Transceiver Station (BTS), a proxy server, a web server, a Short Message Service Center (SMSC), a Multimedia Message Service Center (MMSC), an E-mail server, an Instant Message (IM) server, a catalog server, a Residential Gateway, a Smart Client Software Factory (SCSF), a Set Top Box (STB), and a network server. Examples of the search universe 106 can include, but are not limited to the Internet, mobile internet, databases, and servers. Further, the communication device 102 can receive a set of persistent search query results, based on the search query, from the network device 104.

Typically, a persistent search query includes a search criteria, a set of result delivery parameters, and initial context information. The search criteria can be a search keyword or a search string. The search criteria can be formulated by a user of the communication device. The initial context information can be the initial context information of the communication network 100, the communication device 102, and/or a user of the communication device 102. The set of result delivery parameters can be based on a context of the communication network 100, the communication device 102, and/or the communication device 102. Examples of the context of the communication network 100 can be bandwidth available in the communication network 100 and traffic in the communication network 100. Examples of the context of the communication device 102 such as a mobile phone include, but are not limited to, current location of the mobile phone, memory available in the mobile phone, status of an application on the mobile phone, status of a call at the mobile phone, last key pressed on the mobile phone, and window size for delivering search query results on the mobile phone. Examples of the context of the user include current location of the user, user preferences about an application, and user preferences about delivery of search results.

The communication device 102 can send the persistent search query to the network device 104 by using different type of transmission techniques. Further, the communication device 102 can be configured to automatically send the context information update to the network device 104 whenever there is a change in the context of the communication network 100 relevant to the persistent search query, the communication device 102 relevant to the persistent search query, and/or the communication device 102 relevant to the persistent search query. For one embodiment, the communication device 102 can send the context information update relevant to the persistent search query after every predefined time interval. The context information update can indicate a current context of the communication device 102 which is relevant to the persistent search query. For one embodiment, the context information update can indicate a current context of the communication network 100 relevant to the persistent search query, and/or the user of the communication device 102 relevant to the persistent search query.

In some cases, the network device 104 can locally store the persistent search query. In this case, the network device can initiate a persistent search for searching a required content in the search universe 106 by using the stored persistent search query. Further, for come cases the communication device 102 can locally store the persistent search query. In this case, the persistent search can be initiated by the communication device 102 for searching the desired content in the search universe 106.

The search universe 106 can be a set of one or more databases or servers with stored content. For example, the search universe 106 can include databases of songs, databases of images, databases of ringtones, databases of wallpapers, databases of software applications. The communication device 102 can persistently search in the search universe 106 via the network device 104 based on the search criteria and the result delivery parameters. The network device 104 sends the persistent search query results to the communication device 102 when the search criteria is satisfied and the context information update matches with the result delivery parameters. The context information update is the context update relevant to the persistent search query. Thereafter, when there is a new addition in the search universe 106 satisfying the search criteria and when the context information update is matching with the result delivery parameters, the network device 104 sends the persistent search query results to the communication device 102.

For example, if a user of the mobile phone wants to search for songs of singer Ricky Martin and wants the search results to be received at a mobile phone when the phone is not in a call, then the network device 104, such as a proxy server, can send a set of songs of Ricky Martin to the mobile phone only when the user is not in a call. Further, the songs of Ricky Martin will be delivered persistently on the mobile phone whenever there is new addition of songs of Ricky Martin in the search universe 106.

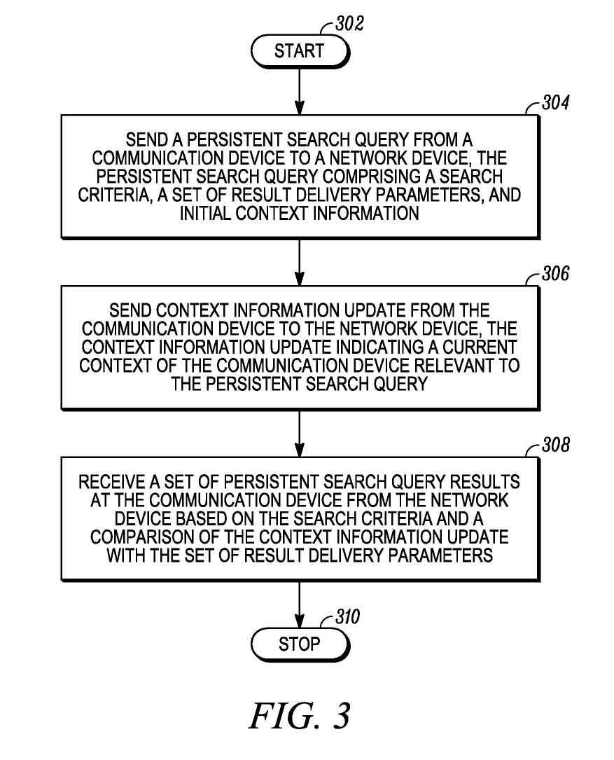

FIG. 2 illustrates a block diagram of the communication device 102, in accordance with various embodiment of the present invention. The communication device 102 can be configured to search for content in the search universe 106 by sending a persistent search query to the network device 104. Examples of the communication device 102 include, but are not limited to, a mobile phone, a smart phone, a pager, a Personal Digital Assistant (PDA), a computer, a transceiver at a Base Transceiver Station (BTS), and a Voice over Internet Protocol (VoIP) phone. Further, the communication device 102 can include accessories like a removable memory card, a Secure Digital (SD) card, a flash memory card, a tethered cable, a Bluetooth® device, and/or a Universal Serial Bus (USB) drive. It will be apparent to a person ordinarily skilled in the art that the communication device with the accessories can be considered as one complete device. Any action carried out by an accessory device can be considered to be carried out by the communication device.

For one embodiment, the communication device 102 can include a persistent query generator 202, a transmitter 204, a receiver 206, and a processor 208. The persistent search query generator 202 is adapted to generate a persistent search query. A persistent search query allows users to enter a search query just once and then receive constant, near real-time, automatic updates whenever new content meeting search criteria is available on a database at the web or mobile communication network. Further, the persistent search query includes a search criteria, a set of result delivery parameters, and initial context information. The search criteria can be a search keyword or a search string. The initial context information can be the initial context information of the communication network 100, the communication device 102, and/or a user of the communication device 102. The set of result delivery parameters is based on the context of the communication network 100, the communication device 102, and/or a user of the communication device 102. For one embodiment, the search criteria, and the set of result delivery parameters can be manually selected by a user of the communication device 102.

The transmitter 204 is adapted to send the persistent search query, generated at the persistent search query generator 202, to the network device 104. The transmitter 204 is further adapted to send context information update relevant to the persistent search query to the network device 104. The context information update can indicate a current context of the communication device 102 relevant to the persistent search query. For one embodiment, the context information update indicates a current context of the communication network 100 relevant to the persistent search query, the communication device 102 relevant to the persistent search query, and/or the user of the communication device 102 relevant to the persistent search query. Further, the transmitter 204 can send the context information update relevant to the persistent search query to the network device 104 when there is any change in context of the communication network 100 relevant to the persistent search query, the communication device 102 relevant to the persistent search query, and/or the user of the communication device 102 relevant to the persistent search query. For one embodiment, the transmitter 204 sends the context information update relevant to the persistent search query to the network device after every predefined time interval.

The communication device 102 further includes the receiver 206, which is adapted to receive a set of persistent search query results at the communication device 102 from the network device 104, based on the search criteria and a comparison of the context information update with the set of result delivery parameters. For one embodiment, the receiver 206 can be adapted to receive a set of persistent search query results from the network device 104 when the search criteria is satisfied and when the context information update matches with the set of result delivery parameters. Further, the receiver 206 can be adapted to asynchronously receive the set of persistent search query results from the network device 104. The communication device 102 also includes the processor 208, which can be adapted to determine the context information update of the communication device 102. For one embodiment, the processor 208 can also be adapted to determine the context information update of the communication network 100 relevant to the persistent search query and the context information update of a user of the communication device 102 which is relevant to the persistent search query.

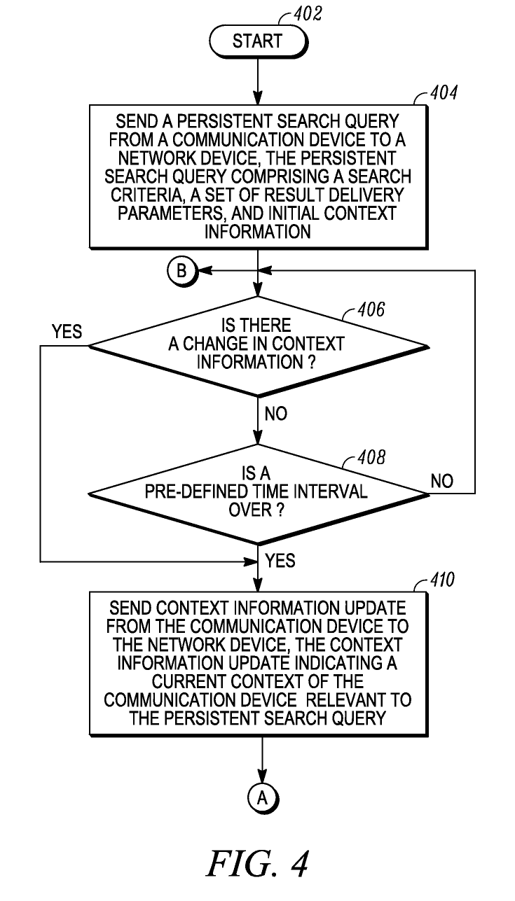

FIG. 3 is a flow diagram illustrating a method for managing persistent search query in the communication network 100, in accordance with an embodiment of the present invention. The method is initiated at step 302. At step 304, a persistent search query is sent from the communication device 102 to the network device 104. The persistent search query can include a search criteria, a set of result delivery parameters, and initial context information. For one embodiment, the persistent search query is generated by the persistent search query generator 202. The search criteria can be a search keyword or a search string. The initial context information can be the initial context information of the communication network 100, the communication device 102, and/or a user of the communication device 102. The set of result delivery parameters is based on the context of the communication network 100, the communication device 102, and/or a user of the communication device 102. For example, the result delivery parameters can be based on context of user of the mobile phone and set to deliver the search results when the user of the mobile phone is not listening to songs on the mobile phone. For one embodiment, the persistent search query is sent by the transmitter 204. The search criteria, and the set of result delivery parameters can be manually selected by a user of the communication device 102.

Further at step 306, context information update relevant to the persistent search query is sent from the communication device 102 to the network device 104. The context information update can indicate a current context of the communication device 102. For one embodiment, the context information update can also indicate a current context of the communication network 100 relevant to the persistent search query, and/or a user of the communication device 102 relevant to the persistent search query. For example, the context information update can indicate the current call status of the mobile phone, i.e. whether the user of the mobile phone is making a call, writing a message, or listening to music. For one embodiment, the context information update is sent by the transmitter 204.

At step 308, a set of the persistent search query results are received at the communication device 102 from the network device 104 based on the search criteria and a comparison of the context information update with the set of result delivery parameters. For one embodiment, the receiver 206 receives the persistent search query results from the network device 104 when the search criteria is satisfied and the context information update matches with the set of result delivery parameters. For another embodiment, the receiver 206 asynchronously receives the set of the persistent search query results from the network device 104 based on the search criteria and the comparison of the context information update with the set of result delivery parameter. Thereafter, the method terminates at step 310.

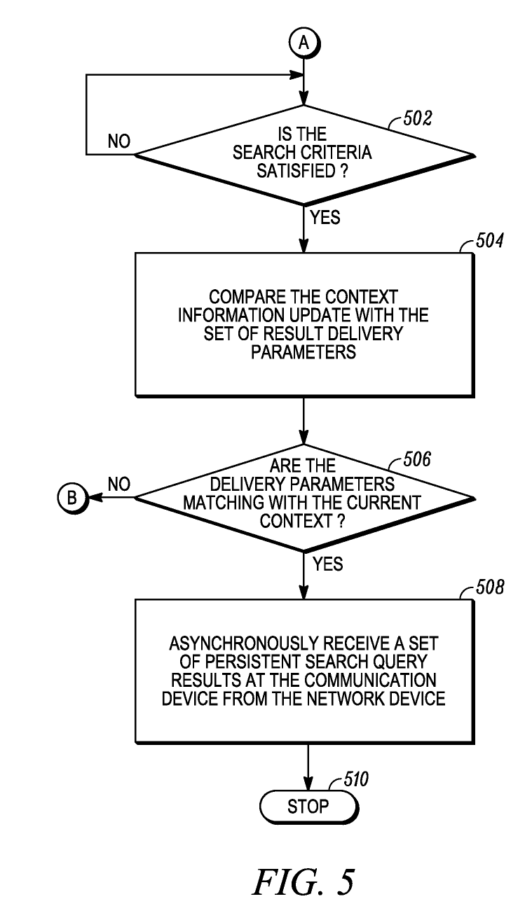

FIGS. 4 and 5 illustrate a flow diagram of a method for managing persistent search query in the communication network 100, in accordance with another embodiment of the invention. The communication network 100 includes the communication device 102, the network device 104, and the search universe 106. The method is initiated at step 402. At step 404, a persistent search query is sent from the communication device 102 to the network device 104. For one embodiment, the persistent search query is generated by the persistent search query generator 202. The persistent search query can be sent by the transmitter 204. The persistent search query includes a search criteria, a set of result delivery parameters, and initial context information. The persistent search query can be sent once and search results can be received at the communication device 102 persistently whenever there is new addition of content satisfying the search query at the search universe 106. The search criteria can be a search keyword or a search string. For example, the search criteria used for persistent search can be “Songs of Bryan Adams”. The set of result delivery parameters can be based on the context of the communication network 100, the communication device 102, and/or a user of the communication device 102. Examples of the delivery parameters can include, but are not limited to, receiving the search results at the communication device 102 when the user of the communication device 102 reaches a particular location, when the user has indicated that previous results have been read, when the communication device 102 is not in a call, and receiving the search results relevant to a current location of the communication device 102.

The initial context information can include initial context of the communication network 100, the communication device 102, and/or the user of the communication device 102. For one embodiment, the search criteria, and the set of result delivery parameters can be manually selected and set by a user of the communication device 102.

For one embodiment, the persistent search query can be stored at the network device 104. In this case the persistent search is initiated by the network device 104. For another embodiment, the persistent search query can be stored at the communication device 102. In this case the persistent search is initiated by the communication device 102.

At step 406, it is determined whether there is a change in context information. For one embodiment, the processor 208 can check whether there is a change in the context information. For example, there can be a change in the context information, when a user carrying the communication device moves from Bangalore to Hyderabad. When there is no change in the context information, then at step 408 it is checked whether a predefined time interval has elapsed. If the predefined time interval has not elapsed, then the method flow goes back to step 406. However, if at step 408 the predefined time interval has elapsed, then step 410 is executed. Also, if at step 406 there is a change in the context information, then step 410 is executed. At step 410, context information update from the communication device 102 is sent to the network device 104. The context information update can indicate a current context of the communication device 102 relevant to the persistent search query. For one embodiment, the context information update can also indicate a current context of the communication network 100 relevant to the persistent search query and/or the user of the communication device 102 relevant to the persistent search query. For example, if a user carrying the communication device moves from Bangalore to Hyderabad, then the context information update can show the current location of the user as Hyderabad. For one embodiment, the transmitter 204 can send the context information update relevant to the persistent search query to the network device 104.

At step 502, it is determined at the network device 104 whether the search criteria are satisfied. In case the search criteria are not satisfied, step 502 is executed. Further, step 502 can be executed till the search criteria are satisfied. If at step 502 it is determined that the search criteria is satisfied, then at step 504 the network device 104 compares the context information update with the set of delivery parameters. At step 506, it is verified whether the delivery parameters are matching with the current context. The current context can be the current context of the communication device 102, the communication network 100, and/or the user of the communication device 102. When the delivery parameters do not match with the current context, the method flow goes back to step 406. However, if at step 506, it is determined that the delivery parameters match with the current context, then step 508 is executed. At step 508, the communication device 102 asynchronously receives a set of persistent search query results from the network device 104. The set of persistent search query results can include web pages, web sites, songs, images, information about hotels, information about cinema halls etc. For one embodiment, the receiver 202 can receive the set of persistent search query results. Thereafter, the method terminates at step 510.

The method for managing persistent search query described in FIGS. 4 and 5 can be understood by the following example. A user may want to persistently receive updates on options of pursuing MBA, available at the Internet, at his mobile phone. In accordance with the invention, the user can form a persistent search query by using search criteria like ‘MBA and B Schools’. Further, the user may want to set certain result delivery parameters for obtaining the relevant results like, window size for displaying the results, format for displaying the results, receiving results when he is not listening to music on his phone, when the network congestion is low, and when he is not making a call. The mobile phone of the user can be configured to send initial context information, like location of the user, current bandwidth being used by the phone, current applications running on the phone etc., to a network device.

On receiving the search criteria, the network device can search a search universe, like the Internet, to obtain available content corresponding to the search string ‘MBA and B Schools’. When the content is available, then the network device can see if the latest context information update received from the user's phone matches with the result delivery parameters. The user's phone automatically sends a context information update to the network device either periodically or when there is a change in the context. In case a match is found between the latest context information update and the result delivery parameters, then the network device can send the persistent search query results to the user's mobile phone, in accordance with the search delivery parameters. Further, as the user is using a persistent search query, there is no requirement to run the search again in order to receive more results. The network device can send the search results whenever any relevant information is available and the context information update matches the result delivery parameters.

Various embodiments of the present invention offer one or more advantages. The present invention provides a method for managing persistent search query in a communication network. The method provides an efficient way to a user of a communication device to persistently search for content such as, images, songs, ringtones, wallpapers, etc. via a persistent search query. The persistent search query allows the user to enter a search query just once and then receive constant, near real-time, automatic updates whenever new content that meets their search criteria is published on the web or at a communication network. The method also enables the user to persistently receive search results at his/her communication device. Further, the method enables the communication device to receive persistent search query results after every pre-defined time interval. The method also enables the communication device to receive search results which are relevant to the current context of the communication device, the communication network, and/or the user of the communication device. In addition, the users can also specify parameters such as “do not receive search results when memory is low at the communication device” or “do not receive search results battery backup of the communication device is low”. Further, the context of the communication device or of the communication network or of the user can change with time. To tackle this, the method provides an efficient way to deliver the persistent search query results based on the changed context, as receiving search results based on current context are more relevant and useful to users.

It will be appreciated that the method and system for managing persistent search query and search results in the communication network, described herein, may comprise one or more conventional processors and unique stored program instructions that control the one or more processors, to implement, in conjunction with certain non-processor circuits, some, most, or all of the functions of the system described herein. The non-processor circuits may include, but are not limited to, signal drivers, clock circuits, power-source circuits, and user-input devices. As such, these functions may be interpreted as steps of the method and system for managing transmissions in the wireless communication network. Alternatively, some or all the functions can be implemented by a state machine that has no stored program instructions, or in one or more application-specific integrated circuits (ASICs), in which each function, or some combinations of certain of the functions, are implemented as custom logic. Of course, a combination of the two approaches can also be used. Thus, methods and means for these functions have been described herein.

It is expected that one with ordinary skill, notwithstanding possibly significant effort and many design choices motivated by, for example, available time, current technology and economic considerations, when guided by the concepts and principles disclosed herein, will be readily capable of generating such software instructions, programs and ICs with minimal experimentation.

In the foregoing specification, the invention and its benefits and advantages have been described with reference to specific embodiments. However, one with ordinary skill in the art would appreciate that various modifications and changes can be made, without departing from the scope of the present invention, as set forth in the claims below. Accordingly, the specification and the figures are to be regarded in an illustrative rather than a restrictive sense, and all such modifications are intended to be included within the scope of the present invention. The benefits, advantages, solutions to problems, and any element(s) that may cause any benefit, advantage or solution to occur or become more pronounced are not to be construed as critical, required or essential features or elements of any or all the claims. The invention is defined solely by the appended claims, including any amendments made during the pendency of this application, and all equivalents of those claims, as issued.

What is claimed is:

1. A method for managing persistent search query in a communication network, the method comprising:
sending a persistent search query from a communication device to a network device, the persistent search query comprising a search criteria, a set of result delivery parameters, and initial context information;
sending a context information update from the communication device to the network device, the context information update indicating a current context of the communication device relevant to the persistent search query; and
receiving a set of persistent search query results at the communication device from the network device based on the search criteria and a comparison of the context information update with the set of result delivery parameters.

2. The method as recited in claim 1, wherein the set of result delivery parameters is based on at least one of a context of the communication network, a context of the communication device, and a context of a user of the communication device.

3. The method as recited in claim 1, wherein the context information update comprises at least one of a context update of the communication network relevant to the persistent search query, a context update of the communication device relevant to the persistent search query and a context update of a user of the communication device relevant to the persistent search query.

4. The method as recited in claim 1, further comprising asynchronously receiving the set of persistent search query results at the communication device from the network device based on the search criteria and a comparison of the context information update with the set of result delivery parameters.

5. The method as recited in claim 1, further comprising sending the context information update relevant to the persistent search query to the network device after every pre-defined time interval.

6. The method as recited in claim 1, further comprising sending the context information update relevant to the persistent search query when at least one of a context of the communication network relevant to the persistent search query, a context of the communication device relevant to the persistent search query, and a context of a user of the communication device relevant to the persistent search query is changed.

7. The method as recited in claim 1, further comprising generating the persistent search query based on a user preference.

8. The method as recited in claim 7, wherein generating the persistent search query comprises creating the search criteria at the communication device.

9. The method as recited in claim 7, wherein generating the persistent search query comprises configuring the set of result delivery parameters.

10. The method as recited in claim 1, further comprising determining the context information update of the communication device relevant to the persistent search query.

11. The method as recited in claim 1, further comprising storing the persistent search query at the network device.

12. A communication device comprising:
a persistent search query generator configured to generate a persistent search query, the persistent search query comprising a search criteria, a set of result delivery parameters, and initial context information;
transmitter configured to:
send a persistent search query to a network device; and
send context information update to the network device, the context information update indicating a current context of the communication device relevant to the persistent search query; and
a receiver configured to:
receive a set of persistent search query results at the communication device from the network device based on the search criteria and a comparison of the context information update with the set of result delivery parameters.

13. The communication device as recited in claim 12, wherein the receiver is further configured to asynchronously receive the set of persistent search query results at the communication device from the network device based on the search criteria and a comparison of the context information update with the set of result delivery parameters.

14. The communication device as recited in claim 12, further comprising a processor configured to determine the context information update relevant to the persistent search query.

15. The communication device as recited in claim 12, wherein the set of result delivery parameters is based on at least one of a context of the communication network, a context of the communication device, and a context of a user of the communication device.

16. The communication device as recited in claim 12, wherein the context information update comprises at least one of a context update of a communication network relevant to the persistent search query, a context update of the communication device relevant to the persistent search query, and a context update of a user of the communication device relevant to the persistent search query.

17. The communication device as recited in claim 12, wherein the network device is selected from the group comprising a search engine, a Base Transceiver Station (BTS), a proxy server, a web server, a Short Message Service Center (SMSC), a Multimedia Message Service Center (MMSC), an E-mail server, an Instant Message (IM) server, a catalog server, a Residential Gateway, a Smart Client Software Factory (SCSF), a Set Top Box (STB), and a network server.

18. The communication device as recited in claim 12, further comprising at least one of a removable memory card, a Secure Digital (SD) card, a flash memory card, a tethered cable, a Universal Serial Bus (USB) drive.
